(19) United States
(12) Patent Application Publication
(10) Pub. No.: US 2025/0285314 A1
(43) Pub. Date: Sep. 11, 2025

(54) Method for automatically quantifying wheat canopy leaf angle distribution based on voxel segmentation normal vector using terrestrial laser scanning data

(71) Applicant: NANJING AGRICULTURAL UNIVERSITY, Nanjing (CN)

(72) Inventors: Xia YAO, Nanjing (CN); Yongqing WANG, Nanjing (CN); Tai GUO, Nanjing (CN); Yangyang GU, Nanjing (CN); Hengbiao ZHENG, Nanjing (CN); Tao CHENG, Nanjing (CN); Chongya JIANG, Nanjing (CN); Yongchao TIAN, Nanjing (CN); Yan ZHU, Nanjing (CN); Weixing CAO, Nanjing (CN)

(73) Assignee: NANJING AGRICULTURAL UNIVERSITY, Nanjing (CN)

(21) Appl. No.: 19/010,781

(22) Filed: Jan. 6, 2025

(30) Foreign Application Priority Data
Jan. 5, 2024 (CN) 202410018558.6

(51) Int. Cl. G06T 7/64; G06T 5/70; G06T 7/10

(52) U.S. Cl. CPC G06T 7/64; G06T 5/70; G06T 7/10; G06T 2207/10028; G06T 2207/20076; G06T 2207/30188

(57) ABSTRACT

A method for automatically estimating a leaf inclination angle distribution of a wheat canopy based on a voxel segmentation normal vector algorithm, including the following steps: step 1: obtaining point cloud data of a wheat canopy; step 2: splicing and denoising point clouds; step 3: calculating normal vectors of the point clouds; step 4: performing voxelization on the point clouds; step 5: segmenting the normal vectors by using a voxel; step 6: calculating angles of the voxels; step 7: collecting statistics on the angles of the voxels and performing curve fitting calculation to obtain a leaf inclination angle distribution and an average leaf inclination angle. The average leaf inclination angle estimated by the method is compared with field measured data, and the feasibility of the algorithm is verified by using a three-dimensional radiative transfer model.

### TECHNICAL FIELD

The present invention relates to the field of non-destructive monitoring of crop life information in precision agriculture, specifically to a method for automatically estimating a leaf inclination angle distribution of a wheat canopy, and more specifically to a method for automatically estimating a leaf inclination angle distribution of a wheat canopy based on a voxel segmentation normal vector algorithm.

### BACKGROUND

Leaf inclination angle distribution is one of the most important structural parameters of crop canopies, and is an important trait related to photosynthesis and affecting radiation transfer in canopies. The leaf inclination angle distribution summarizes the spatial orientations of canopy leaves, and is defined as the probability of a randomly selected leaf being within a unit interval of an inclination angle. Quantification of the variability in the leaf inclination angle distribution can provide strong technical support for high-throughput phenotyping.

Currently, methods for obtaining the leaf inclination angle distribution fall into two types: direct measurement and indirect estimation. Direct measurement methods rely on the use of an inclinometer, a protractor, or other tools for direct contact with the leaf surface, and a large number of leaves need to be measured in order to obtain the leaf inclination angle distribution. Such direct measurement methods are advantageous in high precision, but are time- and labor-consuming and disturb the leaves. Indirect estimation methods are mainly based on optical images and usually involve low costs, but require a large amount of post-processing and human-computer interaction. To address the difficulties in obtaining the leaf inclination angle distribution, scientists have developed several mathematical functions characterized by only one or two parameters. However, the leaf inclination angle distribution of the crop canopy is species-specific, and the simplified mathematical functions fail to take the differences between different species, growth stages, and cultivation management method into consideration.

Terrestrial laser scanning is an active remote sensing technology that emits laser pulses to a spherical space around the scanner and generate a point cloud of a target object by using the time of flight of the emitted pulses to and from the target object. Terrestrial laser scanning has unique advantages in recording three-dimensional positions of plants, and has been widely used for quantifying plant structures. Automatic estimation of the leaf inclination angle distribution of the wheat canopy based on a three-dimensional point cloud is of great significance in promoting high-throughput three-dimensional phenotyping based on a laser scanner. However, conventional methods for estimating the leaf inclination angle distribution of the wheat canopy based on a terrestrial laser scanner lack automatic segmentation for curved leaves and result in an uneven distribution of leaf point density in the canopy.

### SUMMARY

For the shortcomings of the existing technology, an objective of the present invention is to provide a method for automatically estimating a leaf inclination angle distribution of a wheat canopy based on a voxel segmentation normal vector algorithm. According to the method, a wheat canopy is divided into voxels, and a leaf inclination angle distribution is obtained by averaging angles of planes related to each point within each voxel.

To achieve the foregoing objective, the present invention uses the following technical solution: A method for automatically estimating a leaf inclination angle distribution of a wheat canopy based on a voxel segmentation normal vector algorithm includes the following steps:
step 1: obtaining point cloud data of a wheat canopy;
step 2: splicing and denoising point clouds;
step 3: calculating normal vectors of the point clouds;
step 4: performing voxelization on the point clouds;
step 5: segmenting the normal vectors by using a voxel;
step 6: calculating angles of the voxels; and
step 7: collecting statistics on the angles of the voxels and performing curve fitting calculation to obtain a leaf inclination angle distribution and an average leaf inclination angle.

Further, in step 1, point cloud data of a key growth stage of wheat is obtained by using a terrestrial laser scanner.

Further, in step 2, data preprocessing is performed by using software RiScan Pro: first, data of each site is registered and merged, and an average registration error is 1 to 3 mm; then, filtering is performed according to a pulse shape deviation to remove noise points, and ground points are removed by using a terrain filter; and finally, three-dimensional coordinates (x, y, z) of each point are exported for subsequent processing.

Further, the calculating normal vectors of the point clouds in step 3 includes:
a: implementing supervised classification of the point clouds by using a k-nearest neighbors algorithm, and grouping the point clouds to generate point subsets;
b: calculating an eigenvalue and an eigenvector of each point subset by using a singular value decomposition algorithm, where an eigenvector corresponding to a smallest eigenvalue is equivalent to a normal vector of a point; and
c: correcting a direction for a normal vector pointing downward by being multiplied by −1 with a formula of:

$$\vec{N} = \{ \begin{matrix}N , & \vec{N} \geq 0 \\ N * ( - 1 ) , & \vec{N} < 0\end{matrix}$$

where \vec{N} is a normal vector of a point.

Further, the performing voxelization on the point clouds in step 4 includes:
defining a voxel as a three-dimensional space cube, and converting a point cloud into a voxel with a formula of:

$$X = Int ( \frac{x - {x}_{min}}{Δ t} ) , Y = Int ( \frac{y - {y}_{min}}{Δ t} ) , and Z = Int ( \frac{z - {z}_{min}}{Δ t} )$$

where (X, Y, Z) are voxel coordinates, Int indicates that a digit after a decimal point is rounded off to a nearest integer, (x, y, z) represents original point cloud coordinates in the laser scanner data, xₘᵢₙ, yₘᵢₙ, and zₘᵢₙ are minimum values of x, y, and z respectively, Δt is a size of a voxel, and a suitable value of the size of the voxel is determined according to an actual application requirement.

Further, the segmenting the normal vectors by using a voxel in step 5 includes:
a: according to the normal vectors calculated in step 2, setting P=pᵢ(x, y, z) to represent all points in the canopy, where i ∈ [1, N], and N is a quantity of all the points, and setting \vec{N}=\vec{N}ᵢ (a, b, c), where i∈ [1, N], and Nis a quantity of all normal vectors;
b: according to voxel coordinates calculated in step 3, setting v=vⱼ(X, Y, Z), where j ∈ [1, V], and V is a quantity of all voxels;
c: extracting a point in a voxel by using an Open3D library in Python, and setting P=Pₖ(x, y, z) to represent coordinates of points within a voxel, where k ∈ [1, n], and n is a quantity of points within each voxel; and because points and normal vectors are in a one-to-one correspondence, normal vectors within a voxel are \vec{N}=\vec{N}ₖ(a, b, c), where k∈ [1, n], and n is a quantity of the normal vectors within the voxel.

Further, the process of calculating angles of the voxels in step 6 is:
a: Segmentthenormal vectors by using a voxel according to step 4, where normal vectors within a voxel are \vec{N}=\vec{N}ₖ(a, b, c), k∈ [1, n], and n is a quantity of the normal vectors within the voxel, and calculate an angle between \vec{N}ₖ and a zenith direction as an angle of a point pₖ with a formula of:

$${α}_{k} = {cos}^{- 1} ( \frac{\vec{Z} \cdot {\vec{N}}_{k}}{‖ \vec{Z} ‖ \cdot ‖ {\vec{N}}_{k} ‖} ) * ( \frac{180}{π} ) ,$$

where αₖ is an angle of a point, \vec{Z} has vector coordinates of (0, 0, 1) in the zenith direction, and \vec{N}ₖ is a normal vector of the point, and is finally multiplied by (180/π) to convert a radian value into an angle value; and
b: assuming that an angle of a voxel is αⱼ, where j ∈ [1, V], and calculating an average value of angles of normal vectors within the voxel as a voxel angle with a formula of:

$${α}_{j} = \frac{{\sum }_{i = 1}^{n} {α}_{k}}{n} ,$$

where αₖ is an angle of a point within the voxel, and n is a quantity of points within the voxel.

Further, the process of calculating a leaf inclination angle distribution and an average leaf inclination angle in step 7 is:
a: collecting statistics on frequency distributions of angles of all voxels from 0° to 90° according to a step of 1°, and fitting the frequency distributions of the angles of the voxels obtained through statistics into a quadratic function, to obtain the leaf inclination angle distribution; and
b: calculating an average value of the angles of all the voxels as the average leaf inclination angle.

Further, the estimation method further includes verifying feasibility of the algorithm, specifically including:
a: verifying a voxel segmentation normal vector method by using a ray-tracing based three-dimensional radiative transfer model “large-scale remote sensing data and image simulation framework”; and
b: measuring an average leaf inclination angle of the wheat canopy by using an LAI-2200C plant canopy analyzer, and then comparing the average leaf inclination angle with an average leaf inclination angle estimated by using the voxel segmentation normal vector method.

Furthermore, results are comprehensively evaluated by using a coefficient of determination R² and a root mean square error RMSE, where formulas of R² and RMSE are:

$${R}^{2} = 1 - \frac{{\sum }_{i = 1}^{n} {( {Q}_{i} - {P}_{i} )}^{2}}{{\sum }_{i = 1}^{n} {( {Q}_{i} - \overline{P} )}^{2}}$$

$$RMSE = \sqrt{\frac{1}{n} {\sum }_{i = 1}^{n} {( {Q}_{i} - {P}_{i} )}^{2}} ,$$

where Qᵢ is an estimated value, Pᵢ is a true value, P̅ represents an average value of true values, and n represents a total quantity of samples.

Beneficial effects of the present invention are as follows: According to the present invention, for the problems of a lack of automatic segmentation of curved leaves and an uneven distribution of leaf point density in the canopy in the current estimation of the leaf inclination angle distribution of the wheat canopy based on the terrestrial laser scanner, a voxel segmentation normal vector method is developed to automatically segment and spatially normalize curved leaves. In the method, a wheat canopy is divided into voxels, and a leaf inclination angle distribution is obtained by averaging angles of a plane related to each point within each voxel. The effectiveness of the method is verified by using a three-dimensional radiative transfer model. In addition, the estimated average leaf inclination angle of the wheat has a good correlation with the measured value, especially at the booting stage (R²=0.76, and RMSE=) 1.40°. This method implements tracing of leaf inclination angle distribution features among different cultivars, nitrogen levels, growth stages, and canopy heights, and provides technical support for high-throughput phenotyping in the future.

### BRIEF DESCRIPTION OF THE DRAWINGS

FIG. 1 is a flowchart of a method using a single leaf as an example according to the present invention.

FIG. 2 is a visual result of an algorithm using a canopy as an example according to the present invention; where (a) of FIG. 2 shows a wheat canopy point cloud, (b) of FIG. 2 shows a normal vector result, (c) of FIG. 2 shows a voxel result, (d) of FIG. 2 shows a voxel angle, (e) of FIG. 2 shows a voxel angle frequency distribution, and (f) of FIG. 2 shows a leaf inclination angle distribution.

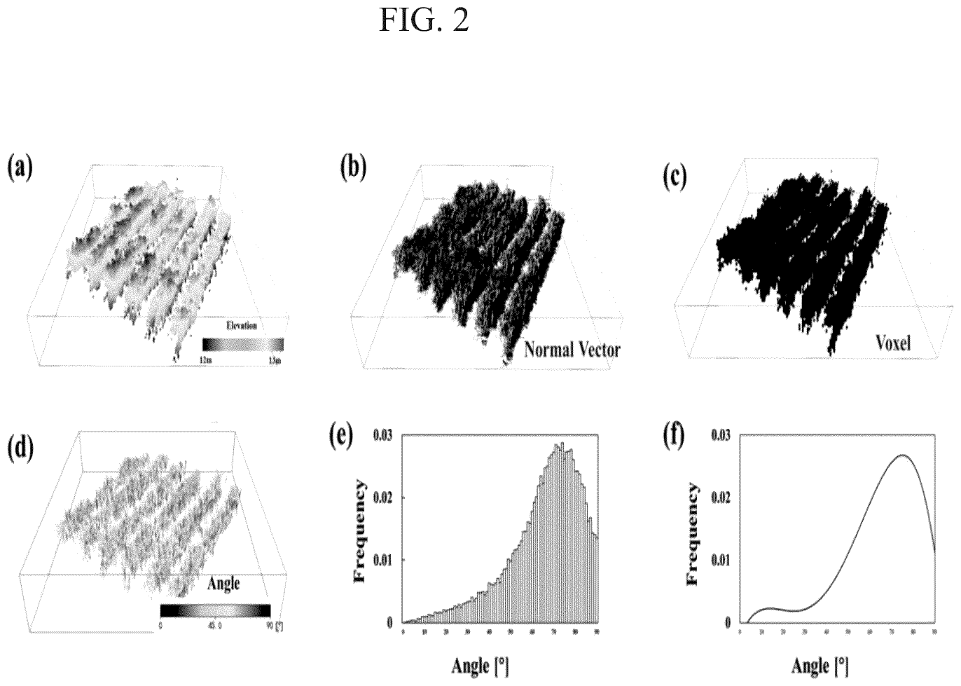

FIG. 3 shows results of leaf inclination angle distributions of a wheat canopy in eight cultivars, four growth stages, and two nitrogen levels.

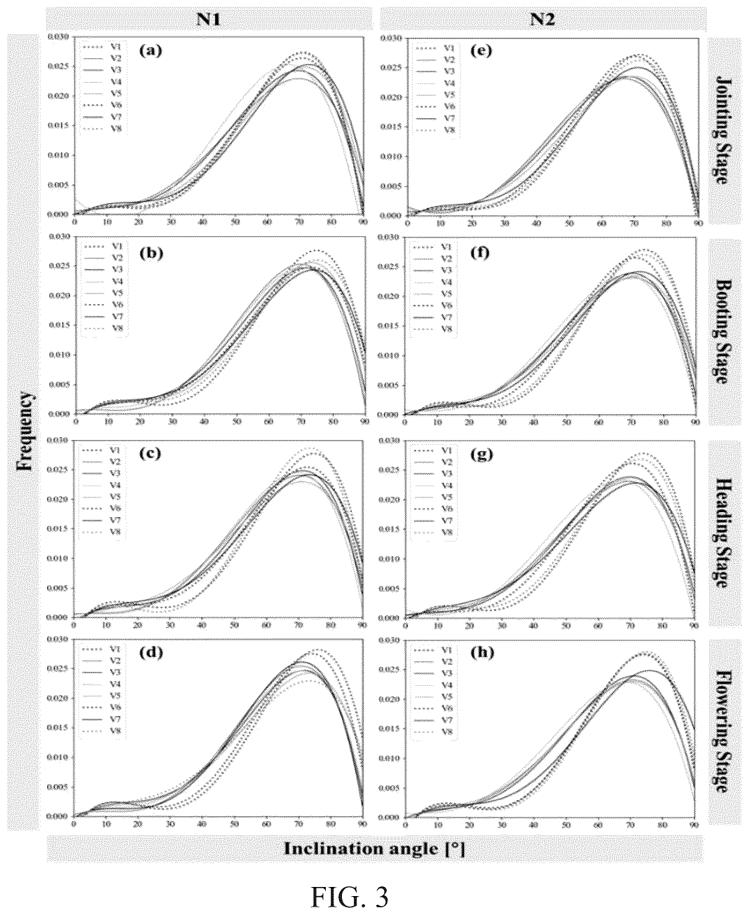

FIG. 4 shows results of a layered average leaf inclination angle of a V1 cultivar at four growth stages processed with N1.

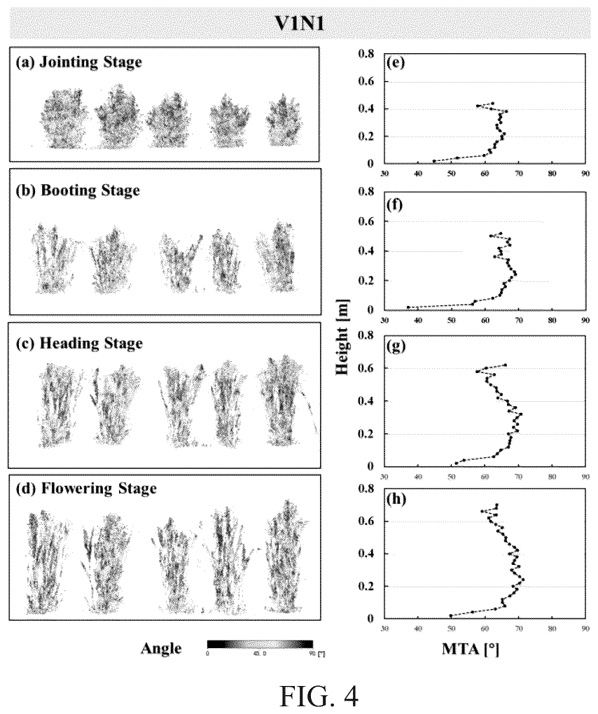

FIG. 5 shows a correlation between an average leaf inclination angle estimated by using the method of the present invention and a measured value.

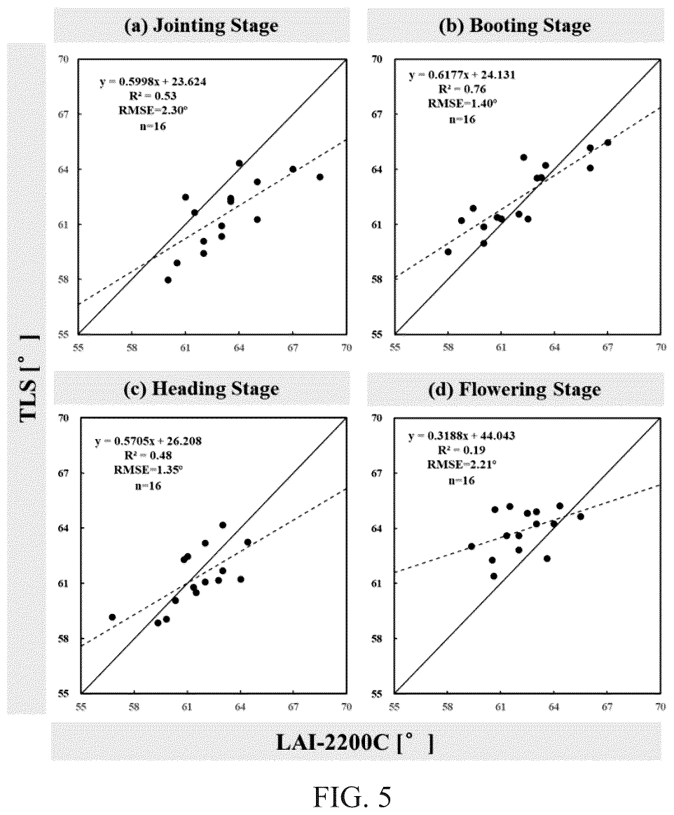

FIG. 6 shows an effectiveness result of estimating a leaf inclination angle distribution by using a verification method based on a three-dimensional radiative transfer model.

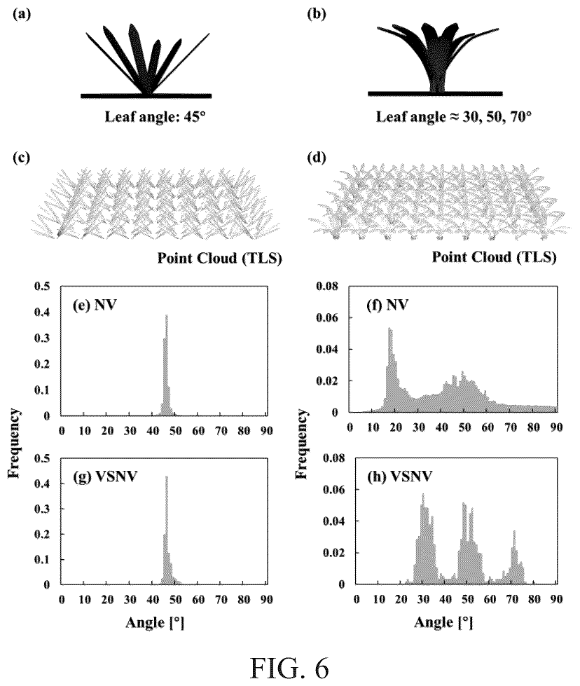

### DETAILED DESCRIPTION

The following describes the present invention in detail with reference to the accompanying drawings and specific embodiments.

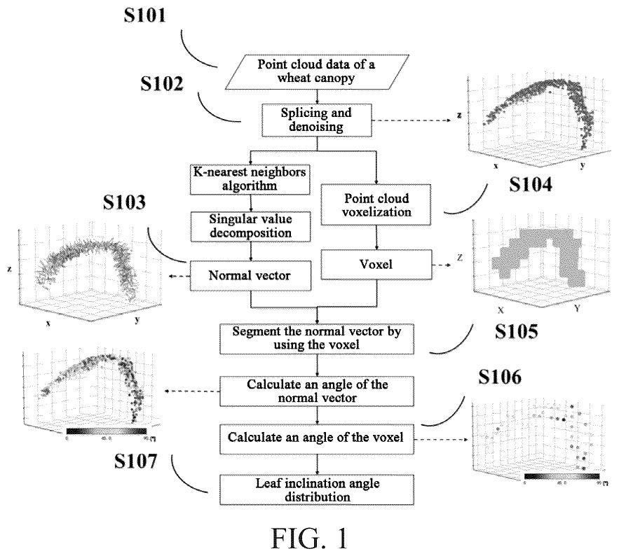

As shown in FIG. 1, a method for automatically estimating a leaf inclination angle distribution of a wheat canopy based on a voxel segmentation normal vector algorithm includes the following steps:

S1: Obtain point cloud data of a wheat canopy.

S2: Splice and denoise point clouds.

S3: Calculate normal vectors of the point clouds.

S4: Perform voxelization on the point clouds.

S5: Segment the normal vectors by using a voxel.

S6: Calculate angles of the voxels.

S7: Collect statistics on the angles of the voxels and performing curve fitting calculation to obtain a leaf inclination angle distribution and an average leaf inclination angle.

S8: Verify feasibility of the algorithm.

In step S1, the point cloud data of the wheat is collected from small regions of different growth stages, different cultivars, and different nitrogen application levels. Eight winter wheat cultivars are selected: Huaimai 33 (V1), Yangmai 23 (V2), Yangfumai 4 (V3), Ningmai 13 (V4), Yangmai 16 (V5), Jimai 22 (V6), Zhenmai 12 (V7), and Yangnong 19 (V8). Leaves of erective cultivars (V1, V6, and V8) are not easy to bend, and leaves of loose cultivars (V2, V3, V4, V5, and V7) are easy to bend. The test sets two nitrogen levels: 150 kg/ha (N1), and 300 kg/ha (N2); one density level: a row spacing of 35 cm; and a total of 16 small regions, where the area of a single small region is 36 m²(6 m×6 m).

Point cloud data of a key growth stage of wheat is obtained by using a terrestrial laser scanner RIEGL VZ-1000. The scanner is mounted on a tripod with a height of 1.8 m, and performs a multi-site scanning mode on each small region, to increase point density and reduce blocking.

In step S2, for splicing and denoising of the point clouds, data preprocessing is performed by using software RiScan Pro matching the instrument RIEGLVZ-1000. First, data of each site is registered and merged, and an average registration error is 1 to 3 mm. Then, filtering is performed according to a pulse shape deviation to remove noise points, and ground points are removed by using a terrain filter. finally, three-dimensional coordinates (x, y, z) of each point are exported for subsequent processing.

In step S3, the normal vectors of the point clouds are calculated. Because a single point cannot be used to calculate a normal vector, each point needs to be grouped with an adjacent point to form a set that can be fitted by a plane, and then the normal vector is calculated by using the plane. A calculation process of the normal vector is:
a: Implement supervised classification of the point clouds by using a k-nearest neighbors algorithm, and group the point clouds to generate point subsets.
b: Calculate an eigenvalue and an eigenvector of each point subset by using a singular value decomposition algorithm, where an eigenvector corresponding to a smallest eigenvalue is equivalent to a normal vector of a point.
c: Correct a direction for a normal vector pointing downward by being multiplied by −1 with a formula of:

$$\vec{N} = \{ \begin{matrix}N , & \vec{N} \geq 0 \\ N * ( - 1 ) , & \vec{N} < 0\end{matrix} ,$$

where \vec{N} is a normal vector of a point.

In step S4, voxelization is performed on the point clouds, where a voxel is defined as a three-dimensional space cube, and a point cloud can be converted into a voxel with a formula of:

$$X = Int ( \frac{x - {x}_{min}}{Δ t} ) , Y = Int ( \frac{y - {y}_{min}}{Δ t} ) , and Z = Int ( \frac{z - {z}_{min}}{Δ t} ) ,$$

where (X, Y, Z) are voxel coordinates, Int indicates that a digit after a decimal point is rounded off to a nearest integer, (x, y, z) represents original point cloud coordinates in the laser scanner data, and xₘᵢₙ, yₘᵢₙ, and zₘᵢₙ are minimum values of x, y, and z respectively. Δt is a size of a voxel, and a suitable value of the size of the voxel needs to be determined according to an actual application requirement.

In step S5, a specific process of segmenting the normal vectors by using a voxel is as follows:
a: According to the normal vectors calculated in step S2, set P=pᵢ(x, y, z) to represent all points in the canopy, where i ∈ [1, N], and N is a quantity of all the points, and set \vec{N}=\vec{N}ᵢ(a, b, c), where i∈ [1, N], and N is a quantity of all normal vectors.
b: According to voxel coordinates calculated in step S3, set v=vⱼ(X, Y, Z), where j ∈ [1, V], and Vis a quantity of all voxels.

c: Extract a point in a voxel by using an Open3D library in Python, and set P=pₖ (x, y, z) to represent coordinates of points within a voxel, where k ∈ [1, n], and n is a quantity of points within each voxel. Because points and normal vectors are in a one-to-one correspondence, normal vectors within a voxel are \vec{N}=\vec{N}ₖ(a, b, c), where k∈ [1, n], and n is a quantity of the normal vectors within the voxel.

In step S6, a specific process of calculating angles of the voxels is as follows:
a: Segment the normal vectors by using a voxel according to step S4, where normal vectors within a voxel are \vec{N}=\vec{N}ₖ(a, b, c), k∈ [1, n], and n is a quantity of the normal vectors within the voxel, and calculate an angle between and a zenith direction as an angle of a point pₖ with a formula of:

$${α}_{k} = {cos}^{- 1} ( \frac{\vec{Z} \cdot {\vec{N}}_{k}}{‖ \vec{Z} ‖ \cdot ‖ {\vec{N}}_{k} ‖} ) * ( \frac{180}{π} ) ,$$

where αₖ is an angle of a point, \vec{Z} has vector coordinates of (0, 0, 1) in the zenith direction, and \vec{N}ₖ is a normal vector of the point, and is finally multiplied by (180/π) to convert a radian value into an angle value.
b: Assume that an angle of a voxel is αⱼ, where j ∈ [1, V], and calculate an average value of angles of normal vectors within the voxel as a voxel angle with a formula of:

$${α}_{j} = \frac{{\sum }_{i = 1}^{n} {α}_{k}}{n} ,$$

where αₖ is an angle of a point within the voxel, and n is a quantity of points within the voxel.

In step S7, a specific process of collecting statistics on the angles of the voxels and performing curve fitting calculation to obtain a leaf inclination angle distribution and an average leaf inclination angle is as follows:
a: Collect statistics on frequency distributions of angles of all voxels from 0° to 90° according to a step of 1°, and fit the frequency distributions of the angles of the voxels obtained through statistics into a quadratic function, to obtain the leaf inclination angle distribution.
b: Calculate an average value of the angles of all the voxels as the average leaf inclination angle.

In step S8, a specific process of verifying feasibility of the algorithm is as follows:
a: Verify a voxel segmentation normal vector method by using a ray-tracing based three-dimensional radiative transfer model “large-scale remote sensing data and image simulation framework” (LESS). The LESS can simulate large-scale remote sensing data and images of real 3D scenarios. A straight leaf (with a leaf inclination angle of) 45°, ideal curved leaves (with leaf inclination angles of 30°, 50°, and) 70°, and a real curled leaf are provided, and a corresponding wheat canopy scenario is constructed by using the LESS model.
b: Measure an average leaf inclination angle of the wheat canopy by using an LAI-2200C plant canopy analyzer, and then compare the average leaf inclination angle with an average leaf inclination angle estimated by using the voxel segmentation normal vector method. Measurement is performed under a condition of being overcast or being near sunset. In this case, illumination is mainly diffuse. In each plot, measurement is performed at five selected representative sites, and a plot value is represented by using an overall average value. To avoid the impact of weeds, the LAI-2200C is maintained at a height of approximately 10 cm from the ground during measurement under the canopy.
c: Evaluate results comprehensively by using a coefficient of determination R² and a root mean square error RMSE, where formulas of R² and RMSE are:

$${R}^{2} = 1 - \frac{{\sum }_{i = 1}^{n} {( {Q}_{i} - {P}_{i} )}^{2}}{{\sum }_{i = 1}^{n} {( {Q}_{i} - \overline{P} )}^{2}}$$

$$RMSE = \sqrt{\frac{1}{n} {\sum }_{i = 1}^{n} {( {Q}_{i} - {P}_{i} )}^{2}} ,$$

where Qᵢ is an estimated value, Pᵢ is a true value, P̅ represents an average value of true values, and n represents a total quantity of samples.

The average leaf inclination angle estimated by using the constructed method has a good correlation with the measured value, especially at the booting stage (R²=0.76, and RMSE=) 1.40°.

The basic principles, main features, and advantages of the present invention are shown and described above. A person of ordinary skill in the art should understand that the foregoing embodiments do not limit the protection scope of the present invention in any form, and any technical solution obtained by using equivalent replacement or the like falls within the protection scope of the present invention. All parts not involved in the present invention are the same as the existing technology or can be implemented by using the existing technology.

1. A method for automatically estimating a leaf inclination angle distribution of a wheat canopy based on a voxel segmentation normal vector algorithm, comprising the following steps:
step 1: obtaining point cloud data of a wheat canopy;
step 2: splicing and denoising point clouds;
step 3: calculating normal vectors of the point clouds;
step 4: performing voxelization on the point clouds;
step 5: segmenting the normal vectors by using a voxel, comprising:
a: according to the normal vectors calculated in the step 3, setting P=pᵢ(x, y, z) to represent all points in the canopy, wherein i ∈ [1, N], and N is a quantity of all the points, and setting \vec{N}=\vec{N}ᵢ(a, b, c), wherein i∈ [1, N], and Nis a quantity of all normal vectors;
b: according to voxel coordinates calculated in the step 4, setting v=vⱼ(X, Y, Z), wherein j ∈ [1, V], and V is a quantity of all voxels;
c: extracting a point in a voxel by using an Open3D library in Python, and setting P=pₖ (x, y, z) to represent coordinates of points within a voxel, wherein k ∈ [1, n], and n is a quantity of points within each voxel; and because points and normal vectors are in a one-to-one correspondence, normal vectors within a voxel are \vec{N}=\vec{N}ₖ(a, b, c), wherein k∈ [ ], n], and n is a quantity of the normal vectors within the voxel;
step 6: calculating angles of the voxels; wherein a calculation process is:
a: segmenting the normal vector by using a voxel according to the step 5, wherein normal vectors within a voxel are \vec{N}=\vec{N}ₖ(a, b, c), k∈ [1, n], and n is a quantity of the normal vectors within the voxel, and calculating an angle between \vec{N}ₖ and a zenith direction as an angle of a point pₖ with a formula of:
$${α}_{k} = {cos}^{- 1} ( \frac{\vec{Z} \cdot {\vec{N}}_{k}}{‖ \vec{Z} ‖ \cdot ‖ {\vec{N}}_{k} ‖} ) * ( \frac{180}{π} ) ,$$
wherein αₖ is an angle of a point, Z has vector coordinates of (0, 0, 1) in the zenith direction, and \vec{N}ₖ is a normal vector of the point, and is finally multiplied by (180/T) to convert a radian value into an angle value; and
b: assuming that an angle of a voxel is αⱼ, wherein j ∈ [1, V], and calculating an average value of angles of normal vectors within the voxel as a voxel angle with a formula of:
$${α}_{j} = \frac{{\sum }_{i = 1}^{n} {α}_{k}}{n} ,$$
wherein αₖ is an angle of a point within the voxel, and n is a quantity of points within the voxel; and
step 7: collecting statistics on the angles of the voxels and performing curve fitting calculation to obtain a leaf inclination angle distribution and an average leaf inclination angle; wherein a calculation process is:
a: collecting statistics on frequency distributions of angles of all voxels from 0° to 90° according to a step of 1°, and fitting the frequency distributions of the angles of the voxels obtained through statistics into a quadratic function, to obtain the leaf inclination angle distribution; and
b: calculating an average value of the angles of all the voxels as the average leaf inclination angle.

2. The method for automatically estimating leaf inclination angle distribution of a wheat canopy based on a voxel segmentation normal vector algorithm according to claim 1, wherein in the step 1, point cloud data of a key growth stage of wheat is obtained by using a terrestrial laser scanner.

3. The method for automatically estimating leaf inclination angle distribution of a wheat canopy based on a voxel segmentation normal vector algorithm according to claim 1, wherein in the step 2, data preprocessing is performed by using software RiScan Pro: first, data of each site is registered and merged, and an average registration error is 1 to 3 mm; then, filtering is performed according to a pulse shape deviation to remove noise points, and ground points are removed by using a terrain filter; and finally, three-dimensional coordinates (x, y, z) of each point are exported for subsequent processing.

4. The method for automatically estimating leaf inclination angle distribution of a wheat canopy based on a voxel segmentation normal vector algorithm according to claim 1, wherein the calculating normal vectors of the point clouds in the step 3 comprises:
a: implementing supervised classification of the point clouds by using a k-nearest neighbors algorithm, and grouping the point clouds to generate point subsets;
b: calculating an eigenvalue and an eigenvector of each point subset by using a singular value decomposition algorithm, wherein an eigenvector corresponding to a smallest eigenvalue is equivalent to a normal vector of a point; and
c: correcting a direction for a normal vector pointing downward by being multiplied by −1 with a formula of:
$$\vec{N} = \{ \begin{matrix}N , & \vec{N} \geq 0 \\ N * ( - 1 ) , & \vec{N} < 0\end{matrix} ,$$
wherein \vec{N} is a normal vector of a point.

5. The method for automatically estimating leaf inclination angle distribution of a wheat canopy based on a voxel segmentation normal vector algorithm according to claim 1, wherein the performing voxelization on the point clouds in the step 4 comprises:
defining a voxel as a three-dimensional space cube, and converting a point cloud into a voxel with a formula of:
$$X = Int ( \frac{x - {x}_{min}}{Δ t} ) , Y = Int ( \frac{y - {y}_{min}}{Δ t} ) , and Z = Int ( \frac{z - {z}_{min}}{Δ t} ) ,$$
wherein (X, Y, Z) are voxel coordinates, Int indicates that a digit after a decimal point is rounded off to a nearest integer, (x, y, z) represents original point cloud coordinates in the laser scanner data, xₘᵢₙ, yₘᵢₙ, and zₘᵢₙ are minimum values of x, y, and z respectively, Δt is a size of a voxel, and a suitable value of the size of the voxel is determined according to an actual application requirement.

6. The method for automatically estimating leaf inclination angle distribution of a wheat canopy based on a voxel segmentation normal vector algorithm according to claim 1, wherein the estimation method further comprises verifying feasibility of the algorithm, specifically comprising:
a: verifying a voxel segmentation normal vector method by using a ray-tracing based three-dimensional radiative transfer model “large-scale remote sensing data and image simulation framework”; and
b: measuring an average leaf inclination angle of the wheat canopy by using an LAI-2200C plant canopy analyzer, and then comparing the average leaf inclination angle with an average leaf inclination angle estimated by using the voxel segmentation normal vector method.

7. The method for automatically estimating leaf inclination angle distribution of a wheat canopy based on a voxel segmentation normal vector algorithm according to claim 6, wherein results are comprehensively evaluated by using a coefficient of determination R² and a root mean square error RMSE, wherein formulas of R² and RMSE are:
$${R}^{2} = 1 - \frac{{\sum }_{i = 1}^{n} {( {Q}_{i} - {P}_{i} )}^{2}}{{\sum }_{i = 1}^{n} {( {Q}_{i} - \overline{P} )}^{2}}$$
$$RMSE = \sqrt{\frac{1}{n} {\sum }_{i = 1}^{n} {( {Q}_{i} - {P}_{i} )}^{2}} ,$$
wherein Qᵢ is an estimated value, Pᵢ is a true value, P̅ represents an average value of true values, and n represents a total quantity of samples.
